(19) United States
(12) Patent Application Publication
(10) Pub. No.: US 2004/0233166 A1
(43) Pub. Date: Nov. 25, 2004

(54) Wireless cursor-controlling device with microphone function

(76) Inventors: Chung-Ping Chi, Chung Ho City (TW); Wen-Sheng Liao, Chung Ho City (TW)

Correspondence Address: YI WEN TSENG, 509 ROOSEVELT BLVD. #D306, FALL CHURCH, VA, 22044, US

(21) Appl. No.: 10/443,917

(22) Filed: May 23, 2003

(51) Int. Cl. G09G 5/08

(52) U.S. Cl. 345/158

(57) ABSTRACT

A wireless cursor-controlling device with microphone function is provided. The device includes a transmitter to communicate with an audio frequency signal receiver connected to a computer. The receiver has a corresponding receiving device and an audio frequency amplifying circuit. The audio signal is received by the receiver to be spoken out by a speaker of the receiver, or the audio signal is further inputted to the connected computer to be spoken out by a speaker device of the computer. Therefore, if there is no microphone device, it is facilitate the speaker to use the device to serve as both the wireless computer cursor-controlling device and wireless microphone device.

### BACKGROUND OF THE INVENTION

The present invention relates in general to a wireless cursor-controlling device with microphone function, which combines an inputting device of the computer peripherals with a microphone device.

A computer is more and more popularly used for a briefing in the meeting. It can provide an active performance without the projecting sheets. However, whether the briefing can be smoothly proceeded depends on if the computer can be easily used. While the speaker operates the software of the computer by himself or herself, it may limit the performance. Alternatively, it may need someone else to accompany the speaker. Both of these are not good enough. Therefore, a conventional wireless computer cursor-controlling device is provided for the speaker to hold on hand, such that the computer is controlled via infrared (IR) or radio frequency (RF) transmission. However, the traditional device provided mono cursor-controlling without any extra function is not enough. Thus, there still needs further improvement.

Furthermore, the speaker always walks around the audience for better performance. If there is no microphone device, the movement of the speaker causes a moving voice source. Therefore, it may always exist that the farther people can not clearly hear the speaker. Even though, the microphone device is provided, the speaker has to hold both the microphone device and the wireless cursor-controlling device. Apparently, it is not convenient.

### BRIEF SUMMARY OF THE INVENTION

The present invention provides a wireless cursor-controlling device with microphone function, which includes a transmitter to communicate with an audio frequency signal receiver connected to a computer. The receiver has a corresponding receiving circuit and an audio frequency amplifying circuit. The audio signal is received by the receiver to be spoken out by a speaker of the receiver, or further inputs to the connected computer to be spoken out by a speaker device of the computer. Therefore, if there is no microphone device, it is facilitate the speaker to use the present device as both the wireless cursor-controlling device and the wireless microphone device.

### BRIEF DESCRIPTION OF THE DRAWINGS

These as well as other features of the present invention will become more apparent upon reference to the drawings wherein:

FIG. 1 shows the application of a wireless cursor-controlling device with microphone function according to the present invention;

FIG. 2 shows a circuit diagram of a transmitter of the present device; and

FIG. 3 shows a circuit diagram of a receiver for the present device.

### DETAILED DESCRIPTION OF THE INVENTION

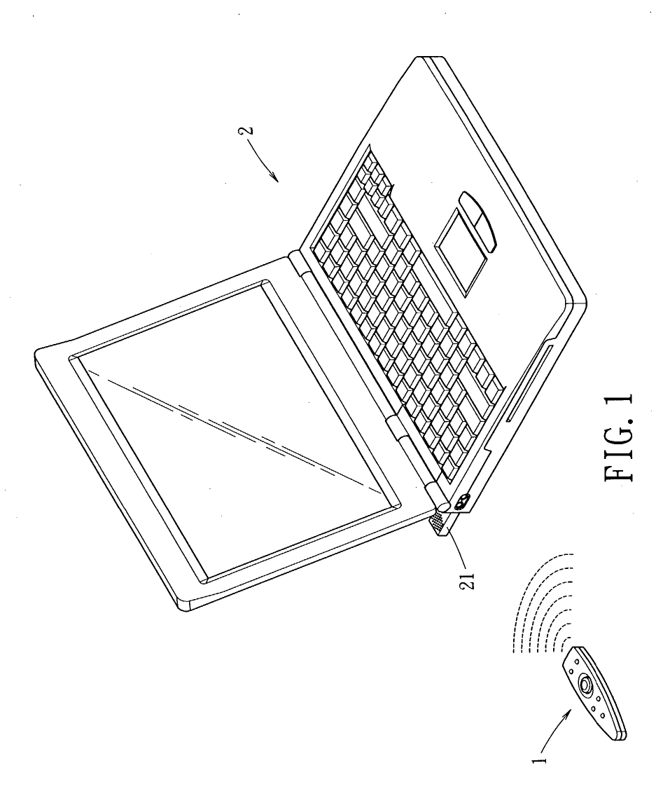

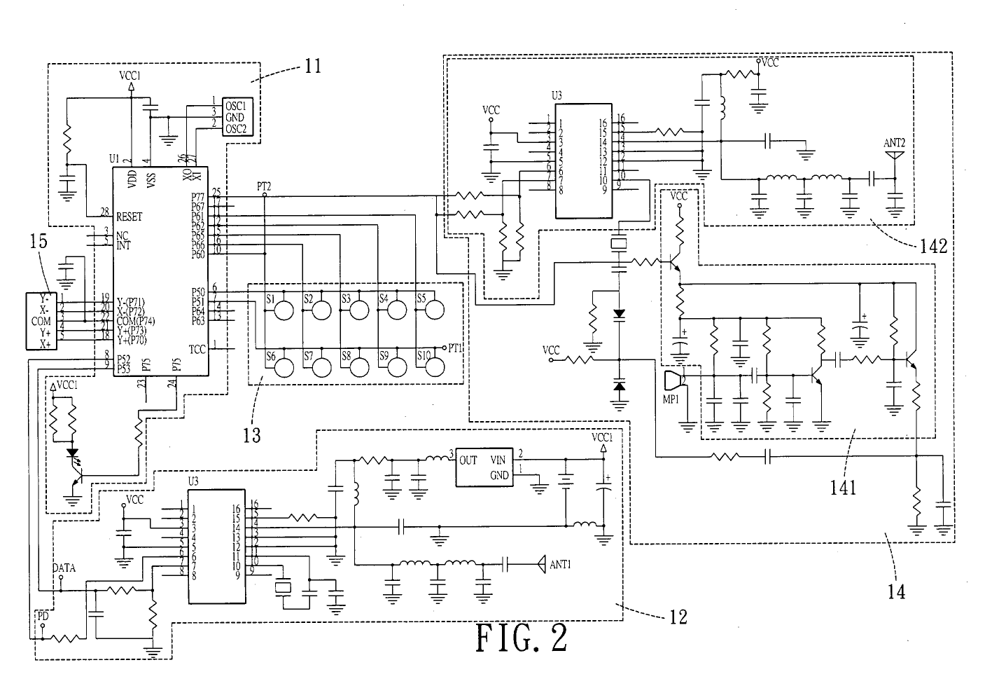

Please refer to FIG. 1, the wireless computer cursor-controlling device with microphone function of the present invention is a hand-held device with the operation similar as a remote controller and a wireless mouse. The present device 1 includes a first housing and a transmitter. Further, a plurality of function buttons are installed on the first housing for remotely controlling a computer 2, such as a laptop computer shown in FIG. 1 or other desktop personal computer, panel computer, hand-held computer and etc, through the receiver 21. As shown in FIG. 2, a circuit diagram of the transmitter includes a first control unit 11, a control signal transmitting circuit 12, a set of buttons 13, an audio frequency processing unit 14 and a two-dimensional cursor-moving controller 15. The first control unit 11 including a microprocessor Ul is connected with the transmitting circuit 12, the buttons 13, the audio frequency processing unit 14 and the cursor-moving controller 15. The buttons 13 includes one or more switches, such as ten switches S1-S10 in this preferred embodiment to provide specific functional control such as page up/down, left/right moving and etc. The first control unit 11 can receive an input as the buttons 13 are pressed and output a respective signal to the transmitting circuit 12. The transmitting circuit 12 then transmits the modulated signal as IR or RF signal to the computer. The cursor-moving controller 15 provides the user to control the movement of the computer cursor. The conventional cursor-moving controller 15 includes a ball button or a gyrostatic ball. When the ball is moving, the cursor-moving controller 15 can generate a locating signal by calculating the direction of the movement. The locating signal is then sent to the first control unit 11 to be transferred as a serial signal for outputting to the transmitting circuit 12. The signal is modulated and transmitted as IR or RF signal to be received by the receiver 21 of the computer 2. After the demodulation by the computer, the computer cursor is accordingly moved under the control of the present device. The audio frequency processing unit 14 includes a microphone MP1, a first audio frequency amplifying circuit 141 and an audio frequency transmitting circuit 142. After a respective button of the buttons 13 is pressed to activate the audio frequency processing unit 14, the voice of the speaker will be received by the microphone MP1, and the audio signal is amplified by the first audio frequency amplifying circuit 141 and outputs to the audio frequency transmitting circuit 142. Similarly, the audio frequency transmitting circuit modulates the amplified audio signal and transmits as IR or RF signal.

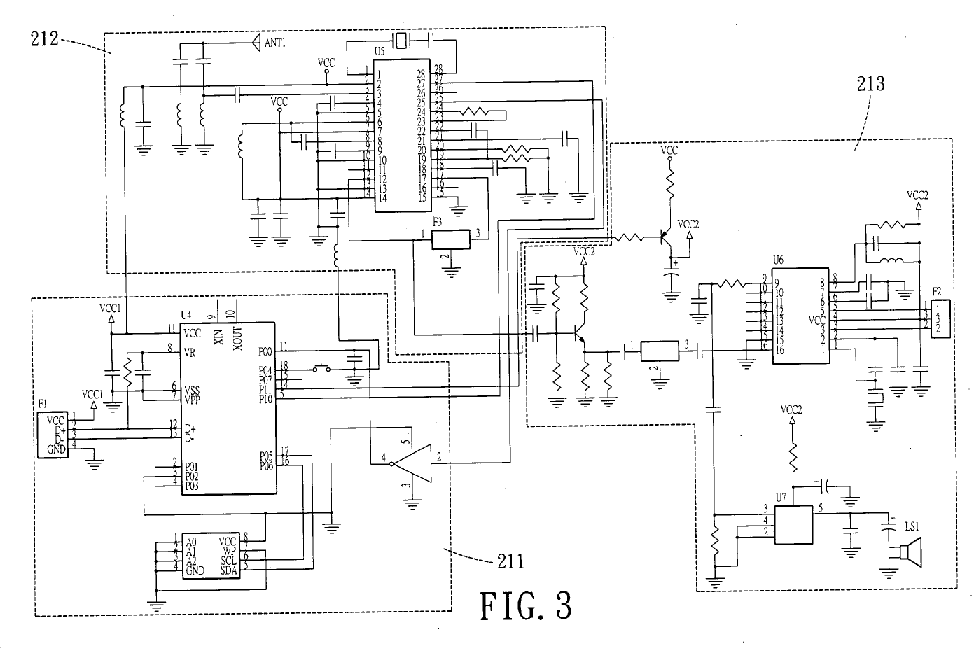

Please refer to FIG. 3, a circuit diagram of the receiver 21 is shown. The receiver 21 has a second housing and a connecting port F1, such as a USB port for connecting to a responding port of the computer 2. The receiver 21 further includes a second control unit 211, a demodulating circuit 212 and a second audio frequency amplifying circuit 213. The second control unit 21 including a microprocessor U4 is connected with the demodulating circuit 212 and the second audio frequency amplifying circuit 213. The control signal, including the locating signal and the button pressing signal, and the audio signal are received and demodulated by the demodulating circuit 212. If the control signal is received, the control signal is sent to the second control unit 211 and transferred to a proper interface signal inputted to the computer via the connecting port F1. The computer 2 is then corresponded to the control signal for a response. If the audio signal is received, the audio signal is demodulated by the demodulating circuit 212 and sent to the second audio frequency amplifying circuit 213. The second audio frequency amplifying circuit 213 includes an audio frequency amplifier, a speaker LSI and an earphone slot F2. The audio frequency amplifier can amplify the inputted audio signal and send the amplified audio signal to be spoken out by the speaker. Furthermore, it may press one of the button 13 to selectively switch the speaker LSI and a earphone (after plugging in the earphone slot F2), or a speaker device of the computer (after transferring the audio signal to a proper interface signal and inputting to the computer 2 via the connecting port F1) for speak out the voice. That is, the wireless computer cursor-controlling device 1 can also be served as a wireless microphone device. The voice of the speaker can be directly speak out through the receiver 21 or speak out by the speaker device of the computer 2.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed:

1. A wireless cursor-controlling device with microphone function comprising a first housing and a transmitter installed in the first housing for communicating with a receiver connected to a computer, the transmitter comprising:
a first control unit for receiving an input and outputting a respective signal;
a cursor-moving controller electrically connected to the first control unit, for detecting a two-dimensional movement of a speaker's operation to generate a locating signal to be inputted to the first control unit;
a control signal transmitting circuit electrically connected to the first control unit, for demodulating the outputting signal from the first control unit and transmitting a demodulated control signal to the receiver of the computer to control the movement of a computer cursor;
a set of buttons installed on the first housing and electrically connected to the first control unit, for activating a specific control signal with respect to a corresponding button being pressed; and
an audio frequency processing unit including a microphone, a first audio frequency amplifying circuit and an audio frequency transmitting circuit, when a respective button of the buttons is pressed to activate the audio frequency processing unit, a voice of the speaker will be received by the microphone, and the audio signal is amplified by the first audio frequency amplifying circuit and outputs to the audio frequency transmitting circuit, so that the audio frequency transmitting circuit modulates the amplified audio signal and transmits to the receiver of the computer,
the receiver comprising a second housing, a second control unit, a demodulating circuit and a second audio frequency amplifying circuit,
the demodulating circuit for receiving the control signal and the audio signal from the transmitter, if the control signal is received, the audio signal is demodulated by the demodulating circuit and sent to the second audio frequency amplifying circuit,
the second audio frequency amplifying circuit including an audio frequency amplifier and a speaker, for amplifying the inputted audio signal and sending the amplified audio signal the speaker to speak out the voice of the speaker.

2. The wireless cursor-controlling device with microphone function of claim 1, wherein the second audio frequency amplifying circuit further includes an earphone slot for plugging an earphone to speak out the voice of the speaker.

3. The wireless cursor-controlling device with microphone function of claim 1, wherein the audio signal is transferred to be inputted to the computer for speaking out the voice through a speaker device of the computer.
